(19) United States
(12) Patent Application Publication
(10) Pub. No.: US 2022/0215016 A9
(43) Pub. Date: Jul. 7, 2022

(54) SYSTEMS AND METHODS FOR STRUCTURAL DATA ANALYSIS

(71) Applicant: SPS Commerce, Inc., Minneapolis, MN (US)

(72) Inventors: LaMoine Zielieke, Knapp, WI (US); Jeremy Henning, Eagan, MN (US); Anthony Arthur, Plymouth, MN (US); Douglas Moses, Eagan, MN (US); Cory Fleming, St. Louis Park, MN (US); Lars Granrud, Minneapolis, MN (US); Matthew Charles Peterson, Vadnais Heights, MN (US); Mark William Dymond, Minneapolis, MN (US)

(21) Appl. No.: 16/830,465

(22) Filed: Mar. 26, 2020

Related U.S. Application Data
(60) Provisional application No. 62/823,995, filed on Mar. 26, 2019.

(51) Int. Cl. G06F 16/245; G06F 16/23; G06Q 10/10; G06K 9/00

(52) U.S. Cl. CPC G06F 16/245; G06K 9/00463; G06Q 10/10; G06F 16/2379

(57) ABSTRACT

Systems and methods for viewing, tracking, and analyzing data structure. Particularly, systems and methods for recognizing and grouping structural components of data into data shapes for viewing, tracking, and analyzing the data structure irrespective of the data content. An example method of analyzing data may include receiving document data comprising a plurality of data fields and defining a data shape from the document data, the data shape having one or more of the plurality of data fields. The data shape is defined agnostic to data content. The data shape may further include a qualifier associated with a data field. The data shape may be a first data shape, and the method may further include defining a second data shape from the document data, the second data shape having one or more of the plurality of data fields. The second shape may comprise the first data shape and an additional element.

### CROSS REFERENCE TO RELATED APPLICATION(S)

This application claims priority to U.S. Provisional Patent Application No. 62/823,995, titled “Systems and Methods for Structural Data Analysis,” filed Mar. 26, 2019, which is hereby incorporated by reference herein in its entirety.

### FIELD OF THE INVENTION

The present disclosure relates to novel and advantageous systems and methods for viewing, tracking, and analyzing data structure. Particularly, the present disclosure relates to novel and advantageous systems and methods for recognizing and grouping structural components of data into data shapes for viewing, tracking, and analyzing the data structure irrespective of the data content.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In many contexts and industries, it may be beneficial to identify trends and inconsistencies among a relatively high volume of documents or information being stored or exchanged. However, such analysis may be difficult and/or time consuming, often requiring an administrator to individually review and compare document data. Moreover, while data may be analyzed based upon random sampling of the data, this can lead to inaccuracies and unreliable results.

The supply chain management industry serves thousands of retailers around the world, speeding the ordering, fulfillment, and disposition of goods and services from tens of thousands of suppliers. Additional participants in this market include distributors, third-party logistics providers, manufacturers, fulfillment and warehousing providers, factoring firms, and sourcing companies. This network of participants can be defined as a retail ecosystem comprised of a network of organizations, including suppliers, distributors, customers, competitors, government agencies, and others involved in the delivery of a specific product or service through both competition and cooperation. The idea is that each business in the “ecosystem” affects, and is affected by, the others, creating a constantly evolving relationship in which each business must be flexible and adaptable in order to survive, as in a biological ecosystem.

Supply chain management solutions in a retail ecosystem must address trading partners' needs for integration, collaboration, connectivity, visibility, and data analytics to improve the speed, accuracy, and efficiency with which goods are ordered and supplied. Supply chain management solutions must further provide for efficient and cost-effective onboarding procedures for new trading partners. A significant hurdle in addressing such concerns is the sheer volume of documents and data exchanged on a daily basis.

Accordingly, there is a need for improved systems and methods for tracking and analyzing trends among data, and particularly with respect to data in a retail ecosystem. More specifically, there is a need for systems and methods to allow for viewing, tracking, and analyzing of the structural components of data exchanged between trading partners in a retail ecosystem.

### SUMMARY

The present disclosure, in an embodiment, relates to a method of analyzing data. The method may generally include receiving document data comprising a plurality of data fields and defining a data shape from the document data, the data shape having one or more of the plurality of data fields. The data shape is defined agnostic to data content. The data shape may further include a qualifier associated with a data field. The data shape may be a first data shape, and the method may further include defining a second data shape from the document data, the second data shape having one or more of the plurality of data fields. The second shape may comprise the first data shape and at least one additional element. The additional element may be a data field.

The present disclosure, in another embodiment, relates to a method of analyzing data. The method may include receiving first document data comprising a plurality of data fields, defining at least one data shape within the first document data, each data shape comprising a grouping of data fields within the first document data, receiving second document data comprising a plurality of data fields, determining if a previously defined data shape is present within the second document data, and determining if the second document data contains a new data shape. The method may further include assigning an identifier to each data shape and storing the identifiers.

### BRIEF DESCRIPTION OF THE DRAWINGS AND APPENDICES

While the specification concludes with claims particularly pointing out and distinctly claiming the subject matter that is regarded as forming the various embodiments of the present disclosure, it is believed that the invention will be better understood from the following description taken in conjunction with the accompanying Figures and Appendices, in which:

FIG. 1 is an example of a document with structural components that may define a plurality of data shapes, according to one or more embodiments.

FIG. 2 is an example of a hierarchy of data shapes that may be defined by the structural components of the document of FIG. 1, according to one or more embodiments.

FIG. 3 is another example of a document with structural components that may define a plurality of data shapes, according to one or more embodiments.

FIG. 4 is an example of raw data for four data groups with structural components that may define a plurality of data shapes, according to one or more embodiments.

FIG. 5 is a flow diagram of a method of data analysis of the present disclosure, according to one or more embodiments.

FIG. 6 is a flow diagram of another method of data analysis of the present disclosure, according to one or more embodiments.

FIG. 7 is an example hierarchy of data shapes that may be defined by the structural components of Appendix 1, according to one or more embodiments.

FIG. 8 illustrates a block diagram schematic of various example components of an example machine upon which any one or more of the techniques or methodologies discussed herein may perform.

Appendix 1, included at the end of the detailed description, is an example of raw data for a document with structural components that may define a plurality of data shapes, according to one or more embodiments.

Appendix 2, included at the end of the detailed description, is an example of a plurality of data shapes that may be defined by the raw data of Appendix 1, according to one or more embodiments.

Appendix 3, included at the end of the detailed description, is another example of raw data for a document with structural components that may define a plurality of data shapes, according to one or more embodiments.

Appendix 4, included at the end of the detailed description, is another example of raw data for a document with structural components that may define a plurality of data shapes, according to one or more embodiments.

Appendix 5, included at the end of the detailed description, is an example of a plurality of data shapes that may be defined by the raw data of Appendix 4, according to one or more embodiments.

### DETAILED DESCRIPTION

The present disclosure relates to systems and methods for viewing, tracking, and analyzing structural components of data. In particular, the present disclosure relates to systems and methods for grouping structural components of data into individual data “shapes,” each data shape representing a unique structural grouping of the data. The data may be or include raw data for a document, parcel, transaction, or a plurality of documents, parcels, or transactions. For example, where the data includes a document, a data shape may be defined by one or more fields of the document and/or one or more field qualifiers. Shapes may be defined based on structural components of the data, and may be agnostic to values or content of the data. In this way, data shapes may be common across multiple documents, parcels, or transactions with shared structure, despite differences in the data content. Data shapes may be used to gain insights into data and may be particularly helpful in understanding structural trends within a high volume of data, such as in a retail ecosystem in which a plurality of trading partners exchange information using a variety of data formats. In particular, by viewing and tracking structural components and structural component groupings throughout the data, structural data similarities, differences, and trends may be identified across trading partners' communications and documents.

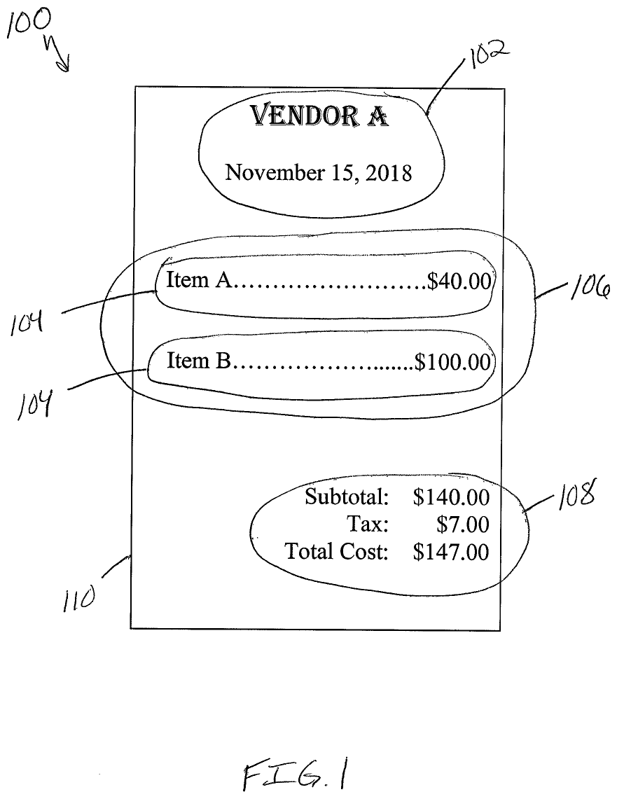

Turning now to FIG. 1, a relatively simple document having a plurality of data fields is shown. In the particular example shown in FIG. 1, the document is a purchase receipt 100 or invoice. However, generally any document or type of document having any number of data fields and/or other structural components may be divided into unique data shapes. As shown in FIG. 1, the receipt 100 may have a header with vendor name and date fields, which may identify the document as a receipt for Vendor A issued on a particular date. The receipt 100 may have a body with fields for line item descriptions and corresponding unit prices. The receipt 100 may have a footer or summary in which subtotal, tax, and total fields may be provided.

In general, some document fields may have associated qualifiers. A qualifier for a data field may designate the type of information contained or expected within that field. For example, a field related to a cost or purchase price may have a currency qualifier such as U.S. dollars, Canadian dollars, Japanese yen, or British pounds designating the unit in which data is expressed in that field. As another example, a data field related to a line item quantity may have a qualifier such as yards, feet, or cases designating the unit by which the line item quantity is expressed. Qualifiers may thus provide context for data fields. However, qualifiers may be agnostic to the particular content of the data fields (i.e., the particular dollar amounts, quantities, etc.). Moreover, some data fields may be provided without qualifiers.

The data fields within the document and their arrangement may be used to define data shapes corresponding to the document that are agnostic to the particular data content. For example and with particular reference to FIG. 1, a first shape may be a “header” shape 102 and may be defined to include fields within the document header. Thus, a “header” shape 102 corresponding with the receipt 100 of FIG. 1 may include the vendor name and date fields. Importantly, while the first shape 102 may be defined to include fields for the vendor name and date, the shape may generally exclude the actual name of this particular vendor and the actual date on which the particular receipt 100 was issued. That is, the shape 102 may exclude the particular values of the data fields. Thus, another receipt issued by a different vendor on a different date may nonetheless have a same “header” shape 102 if it includes vendor name and date fields.

With continued reference to FIG. 1, a second shape 104 may be defined to include fields associated with one or more line items listed in the receipt 100. For example, a “line item” shape 104 may include fields for a first line item description and an associated cost. Because the line item shape 104 is defined agnostic to the content of the particular products or services purchased, where the receipt 100 includes more than one line item, the receipt may thus include more than one copy of the line item shape 104.

In some embodiments, a shape may be defined to include other shapes (which may be referred to as sub-shapes). For example and with respect to FIG. 1, a “total line items” shape 106 may be defined to include both copies of the “line item” shape 104. Thus, where another receipt includes two line items, the receipt may thus include the “total line items” shape 106. However, where another receipt includes more or fewer line items, the receipt may thus not include the same “total line items” shape 106. Instead, it may have a shape defined to include a different total number of line items or line item shapes.

Another shape associated with the receipt of FIG. 1 may be a “summary” shape 108 that may include subtotal, tax, and total cost fields. As with other shapes, the “summary” shape 108 may be defined agnostic to the particular currency amounts listed in the subtotal, tax, and total cost fields. Thus, a different receipt having subtotal, tax, and cost fields may include the same “summary” shape 108, despite differences in the currency amounts.

Yet another shape that may be associated with FIG. 1 may be an overall “receipt” shape 110. The “receipt” shape 110 may be defined to include each of the “header” 102, “line items” 104, 106, and “summary” 108 shapes. Thus, a different receipt that also includes the “header” 102, “line items” 104, 106, and “summary” 108 shapes as those are defined above may also include the “receipt” shape 110. However, where a different receipt has different fields, the receipt may have a different overall receipt shape.

With respect to the receipt 100 of FIG. 1, other shapes may be defined to include different groups of fields and/or shapes. For example, a shape may be defined to include fields within the header and within the summary. A shape may be defined to include fields within the header and the body of the document. As another example, a shape may be defined to include fields for the date and the total of the receipt. Other shapes may be defined based on the receipt as well. In general, a shape may be defined to include at least one element, or in some embodiments at least two elements, wherein each element may be a field, qualifier, field type, or sub-shape.

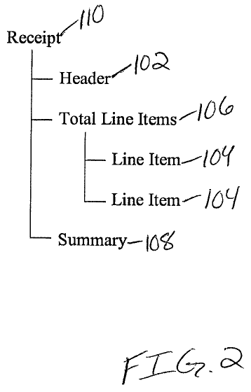

FIG. 2 illustrates a hierarchy of each of the shapes described above with respect to the receipt 100 of FIG. 1. As shown in FIG. 2, the receipt 100 may include two copies of the “line item” shape 104, corresponding with the two line items listed in the receipt. Moreover, the “total line items” shape 106 may be defined to include both of those copies. The “receipt” shape 110 may include each of the other shapes defined in the document.

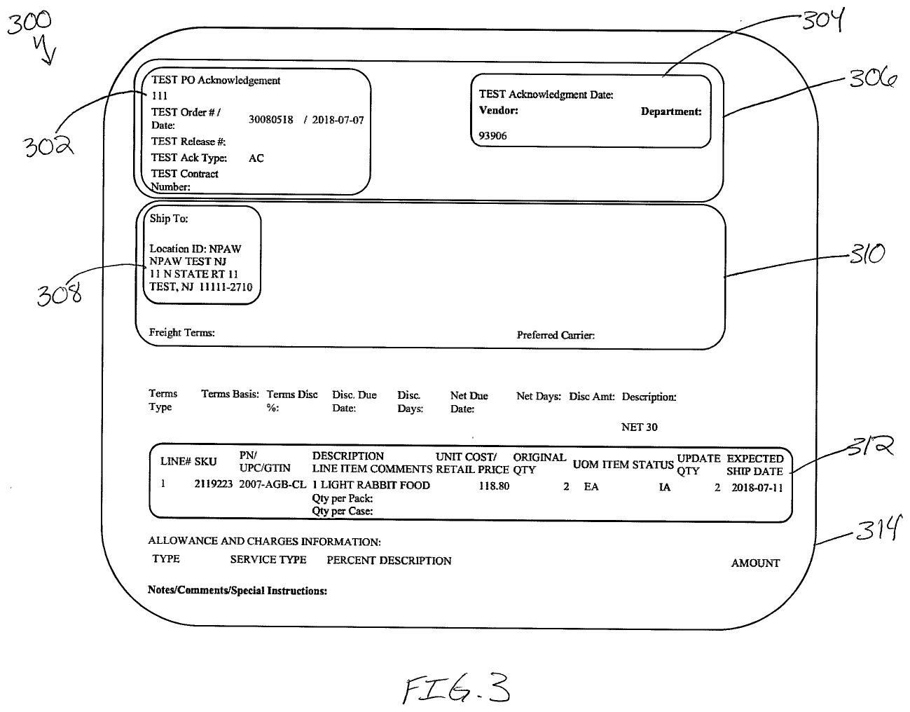

FIG. 3 provides another example document, such as a purchase order 300, from which a variety of shapes may be defined to analyze and/or track the document structure. As shown in FIG. 3, a first shape 302 may include data fields related to order and contract information, a second shape 304 may include data fields related to a vendor, and a third shape 306 may include both the first and second shapes. A fourth shape 308 may include fields related to a shipping address. For example, the fourth shape 308 may include fields for shipping name, shipping street address, shipping city, shipping state, and shipping zip code. A fifth shape 310 may include the fourth shape 308 as well as a field related to freight and carrier terms. A sixth shape 312 may include a field related to a line item listed on the purchase order, such as line item number, SKU number, line item description, and/or other line item information. Finally, a seventh shape 314 may include all of the first through sixth shapes. While these are some of the shapes that may be defined from the fields of the FIG. 3 purchase order 300, other shapes with different combinations of fields may be defined additionally or alternatively.

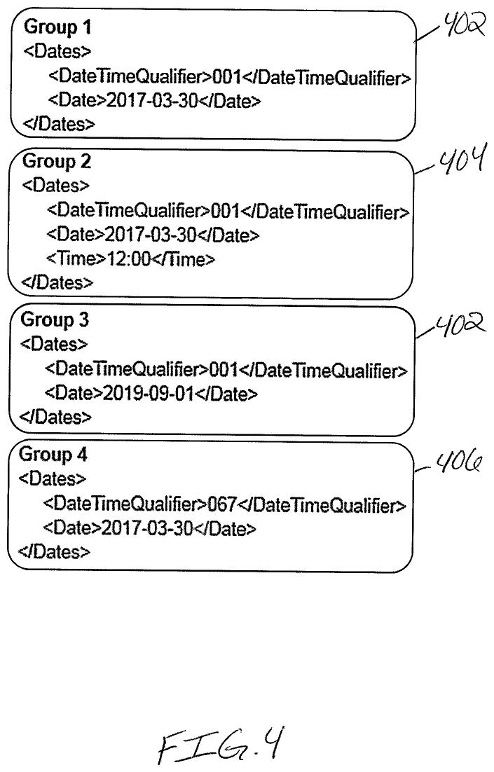

As described above, each shape may be defined by a unique grouping of data fields, qualifiers, and/or sub-shapes. Additionally, each shape may be assigned a unique identifier, such as a numerical or alphanumeric hash identifier. Such identifiers may be used to help identify repeating shapes among a volume of documents or data sets. For example, FIG. 4 illustrates four sample data groups from different parcels, documents, transactions, and/or different sources in order to generally illustrate similar and dissimilar shapes amongst such different sources. In this particular example, each data group includes date information and/or time information. As an example, each data group may relate to a date/time associated with a shipping notification.

The first data group (Group 1) may have two elements: a date field and a qualifier for the date field. The qualifier may be a DateTimeQualifier of 001, which may define a particular format or scheme for expressing date and time. Thus, a first data shape 402 may be defined by a date field with an associated DateTimeQualifier of 001. The first shape 402 may be defined without any regard to the particular date entered within the date field. The second data group (Group 2) may have three elements: a date field, a qualifier for the date field, and a time field. The qualifier may be a DateTimeQualifier of 001. Although the second data group of FIG. 4 contains two of the elements that are also in the first group, the addition of a new element may create a new shape. Thus, a second shape 404 may be defined by a date field with an associated DateTimeQualifier of 001 and a time field. It is to be appreciated that the second data group may also include the first shape 402, defined by the date field and qualifier of the second data group. However, when taken as a whole, the three elements of the second data group (date, date qualifier, and time) may define a new shape.

The third data group (Group 3) may be have two elements: a date field and a qualifier of DateTimeQualifier 001 for the date field. Thus, the third data group may include the first shape 402. It may thus be appreciated that although the first and third data groups have different dates (Mar. 30, 2017 and Sep. 1, 2019, respectively), the two data groups may both include the same data shape 402. This is because shapes may be defined by data structure and may be agnostic to data content. A fourth data group (Group 4) may also include a date field and a qualifier associated with the date field. However, the qualifier of the fourth data group may be DateTimeQualifier 067, different than DateTimeQualifier 001. Due to this variation in the qualifier, the fourth data group may define a different shape than that of the first and third data groups. Thus, the fourth data group may define a third shape 406 having a date field and a qualifier of DateTimeQualifier 067. It is further to be appreciated that despite the first, second, and fourth data groups having a same date (Mar. 30, 2017), each of the data groups defines a different shape, due to varied structure among the data groups. Once again, data shapes may be defined based on structural elements of the data and may disregard content of the data.

Appendices 1-5, included at the end of the detailed description, illustrate more detailed examples of shapes that may be defined from raw data, and how those shapes may be common to multiple documents despite other differences among the documents. This is discussed in more detail below.

Appendix 1 provides an example of raw document or transaction data associated with a document that may be analyzed to determine data shapes. The data shown in Appendix 1 relates to a purchase order. However, as described above, data associated with other documents or document types may be analyzed to define shapes, and the various embodiments of the present disclosure are not limited to purchase orders. As shown in Appendix 1, the document may have a variety of fields. For example, the document may have a header containing information such as a trading partner or vender identifier, a purchase order number, a purchase order date, and/or other data. The document may have one or more line items listing part numbers, product identifiers, purchase prices, and/or other line item data. The document may additionally have a summary listing a line item total and/or other data.

Appendix 2 illustrates some example shapes that may be defined by the document data of Appendix 1. While particular shapes are shown in Appendix 2, it is to be appreciated that the various fields and qualifiers of Appendix 1 may be combined differently to form additional or alternative shapes. Looking to Appendix 2, a first shape (Shape 1) may be an order header shape. The first shape may have a hash identifier and a name The first shape may be defined by its children, which may include a trading partner identifier field, a purchase order number field, a purpose code field, a purchase order date field, an acknowledgement type field, an acknowledgement date field, and a vendor field. As described above, the shapes may be agnostic to the particular content of the data. For example, while the first shape includes a trading partner identifier field, the first shape may exclude that the document of Appendix 1 has the particular trading partner identifier of “SIMMONS.” Another purchase order having the same fields but different content may thus be identified as having the same order header shape.

Moreover, some fields within shapes may include a qualifier to further define the type of data associated with the field. As a particular example, an order quantity field, shown in Appendix 2 as included in the fifth shape, may have a qualifier of “EA” or “each,” meaning that the quantity field is expressed in terms of a number of items, rather than for example a number of yards or cases. Some fields within shapes may additionally or alternatively include a field type to further define the data associate with the field. Some examples of field types may include string, stringset, date, and decimal. For example, a purchase order date field may be associated with a field type of “date,” a purchase price field may be associated with a field type of “decimal,” and a part number field may be associated with a field type of “string.” Other field types may be used additionally or alternatively to define the type of data associated with a field. It is to be appreciated that where two shapes have the same fields, but different qualifiers and/or different field types, the two shapes may be different and thus may have different hash, or other, identifiers.

With continued reference to Appendix 2, a second shape (Shape 2) may have a hash identifier and may include an address shape which, once again, may be agnostic to the actual address associated with the particular purchase order. A third shape (Shape 3) may be a header shape and may be defined by a combined grouping of the first and second shapes, indicating that the third shape includes the sub-shapes identified by those hash identifiers (i.e., Shape 1 and Shape 2). As shown in Appendix 2, the third shape may have its own hash identifier, and the third shape's children may include the hash identifiers for each of the first and second shapes. A fourth shape (Shape 4) may be a product identifier shape. As further shown in Appendix 2, other shapes may include an order line shape (Shape 5), a line item acknowledgment shape (Shape 6), a product or item description shape (Shape 7), one or more line item shapes (Shapes 8 and 9), and a summary shape (Shape 10). Other shapes may be defined by the data of Appendix 1 as well.

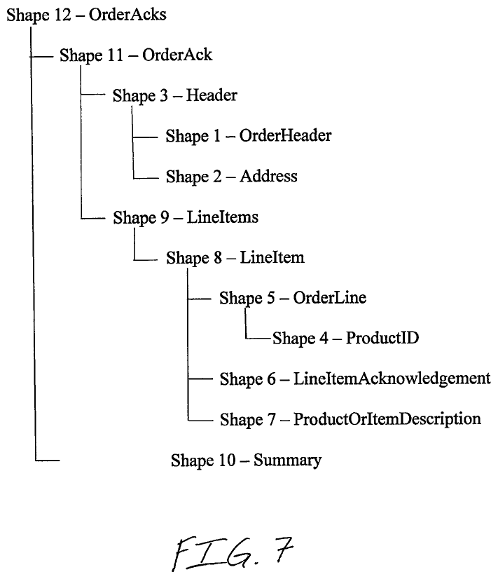

It is to be appreciated that a document, parcel, or data set may have more than one copy of a shape. For example, the data of Appendix 1 includes two line items (BuyerPartNumber V000063716 and BuyerPartNumber V000063715). Each line item may define a shape, and in some embodiments, each line item may individually define the same shape (thus providing two copies of a same shape). Although the particular products, quantities, and costs may be different between the two line items, each line item may include, for example, fields for a line sequence number, a buyer part number, a vendor part number, an order quantity, a purchase price, and/or other fields. The data of Appendix 1 may thus include two copies of a line item shape (Shape 8). This is shown with reference to Appendix 2 in that Shape 9, a Line Items shape which includes all line items of Appendix 1, includes two copies of Shape 8, each representing an individual line item.

Where some shapes include other shapes, the shapes may define a relational hierarchy. As described above with respect to Appendix 2, the header shape (Shape 3) may include the address shape (Shape 2) and the order header shape (Shape 1). As further shown in Appendix 2, other shapes may depend from one another as well. FIG. 7 illustrates a hierarchy of the shapes of Appendix 2. Shape 11 may be an order acknowledgment shape that includes each of Shapes 1-9. Shape 12 may be a further overarching shape that includes each of Shapes 1-11.

Appendix 3 demonstrates document or transaction data for a purchase order that is different from that of Appendix 1, but that nonetheless includes the same data shapes. For example, the purchase order of Appendix 3 has a different purchase order number, acknowledgment date, address, and line items than the purchase order of Appendix 1. However, the two purchase orders have the same structure, including the same fields and qualifiers, and thus both include Shapes 1-12 of Appendix 2 arranged in the same hierarchy. These two purchase orders demonstrate that shapes may be used to define or analyze structure of documents, which may be agnostic to the particular content of the documents. In this way, shapes may be used to identify repeating structural elements among different documents.

Appendix 4 provides an example of raw document or transaction data associated with yet another purchase order. The purchase order of Appendix 4 is both substantively and structurally different than that of Appendix 1. In particular, the purchase order of Appendix 4 only has one line item, whereas the purchase order of Appendix 1 has two line items. Appendix 5 shows an example of shapes that may be defined by the data of Appendix 4. As shown in Appendix 5, Shapes 1-8 of the Appendix 4 purchase order are identical to Shapes 1-8 of the Appendix 1 purchase order. However, because the purchase order of Appendix 4 only includes one line item, there is only one line item shape (Shape 8) present.

With respect to Appendices 1 and 2, Shape 9 is a Line Items shape that is defined to include two copies of Shape 8 (i.e. two line items). Because the purchase order of Appendix 4 only contains one copy of Shape 8 (only one line item), it thus does not include a copy of Shape 9. Instead, as shown in Appendix 5, the purchase order of Appendix 4 includes a Shape 13 that is defined to include one copy of Shape 8 (one line item). Moreover, because Shapes 11 and 12 of Appendices 1 and 2 are defined to include Shape 9, the purchase order of Appendix 4 also does not include these shapes. Instead, as shown in Appendix 5, the purchase order of Appendix 4 includes Shapes 14 and 15. Appendices 4 and 5 thus demonstrate that while two purchase orders, or other documents, may appear relatively similar and contain similar content, differences in the underlying structure of the data may produce different data shapes.

Systems and methods described herein may be applied to a variety of data types and within a variety of environments. As one particular example, systems and methods of data analysis described herein may be applied to data streams within the supply chain management industry. For example, a retail ecosystem network may include suppliers, distributors, customers, competitors, government agencies, and/or other trading partners or participants involved in the delivery of products or services. Such a network may include a vast number of trading partners exchanging purchase orders, acknowledgments, receipts, invoices, and/or other data and communications. The systems and methods described herein may be applied to data and communications exchanged between trading partners to analyze and track the data using shapes. One example of a retail ecosystem in which shapes may be helpful is described in U.S. application Ser. No. 14/169,347, entitled Data Acquisition, Normalization, and Exchange in a Retail Ecosystem and filed Jan. 31, 2014, the content of which is hereby incorporated by reference herein in its entirety.

In a retail ecosystem or other data network, a transaction may be any exchange of information between trading partners or participants. For example, a transaction may be or include a purchase order, receipt, invoice, shipping notification, and/or other communication. As part of a transaction, document data may be transformed to and from different trading partners' document formats and/or standardized or intermediate formats. For example and as described in U.S. application Ser. No. 14/169,347, previously incorporated herein by reference, a document may be transformed from a first trading partner's format to one or more normalized or intermediate formats, and may further be transformed to a second trading partner's format. Each transformation of the document data may produce a different parcel or version of the document data, or in some cases multiple parcels or versions of the document data. In this way, each transaction may be associated with two, three, four, or more parcels, each of which may include a different version or form of the transaction data. Where data for a transaction (such as a request for a price quote) is transformed into multiple trading partners' document formats, the various transformations may result in even more parcels being associated with the transaction.

The various parcels associated with a transaction may have variations in data structure, which may result in different data shapes. In some embodiments, each parcel associated with a transaction may be analyzed to determine data shapes within the parcel. In other embodiments, only some of the parcels associated with a transaction may be analyzed for data shapes. For example, where a document is received in a first trading partner's format, transformed into one or more standard formats, and finally transformed into a second trading partner's format, shapes may be determined only with respect to parcels that correspond with the first and second trading partners' formats and with some or all of any standard formats. In some embodiments, any parcels or transformations corresponding with standard formats used between a first and last standard format may be ignored when determining shapes. In other embodiments, shapes may be determined with respect to additional or alternative formats, parcels, or transformations.

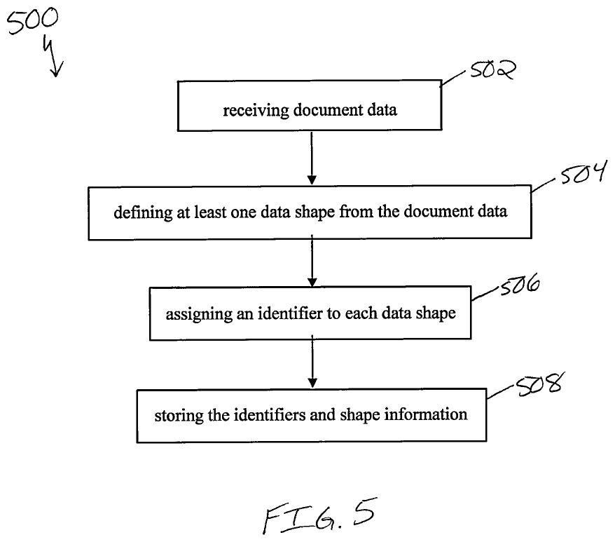

Turning now to FIG. 5, a method 500 of data analysis is shown according to one or more embodiments. The method 500 may be used to analyze the structure of document data by identifying or defining structural data shapes within the document data. As shown, the method 500 may generally include receiving document data 502, defining at least one shape from the document data 504, assigning an identifier to each data shape 506, and storing the identifiers and shape information 508. In other embodiments, the method 500 may include additional and/or alternative steps.

Receiving document data 502 may include receiving raw data associated with a document, transaction, and/or parcel. For example, data may be received in a XML, HTML, or other suitable EDL or other electronic data format. The first document data may relate to a document or transaction, such as a purchase order, invoice, receipt, shipping notification, price request, price quote, or other communication between at least two entities or trading partners. In other embodiments, the first document data may relate to a different type of document or transaction and may relate to more or fewer entities or trading partners. The first document may be received from an issuing trading partner or entity. For example, document data for a purchase order may be received from the trading partner issuing the purchase order.

Defining at least one shape from the document data 504 may include identifying fields, qualifiers, and/or other data items within the document data and grouping the data items into one or more shapes. As described above, some shapes may include other shapes. For example, in some embodiments, a first shape may be defined to include a grouping of fields and/or qualifiers, and a second shape may be defined to include the first shape and an additional element, such as an additional data field. Further, a third shape may be defined, for example, to include the first and second shapes. In some embodiments, a master shape may be defined to include all other shapes defined within the document data.

In some embodiments, shapes may be defined or identified by examining document data in terms of a hierarchical structure of parent data and child data. For example, data items such as fields and qualifiers within a data group may be considered children of that data group. With particular reference to the document data of Appendix 1, OrderAck may be considered a data group that includes the child Header. Header, in turn, may be considered a data group that includes the children OrderHeader and Address. OrderHeader may be a data group that includes the children TradingPartnerID, PurchaseOrderNumber, TsetPurposeCode, PurchaseOrderDate, AcknowledgementType, AcknowledgementDate, and Vendor. Address may be a data group that includes the children AddressTypeCode, LocationCodeQualifier, AddressLocationNumber, AddressName, Address1, City, State, PostalCode, and Country. A shape may be defined as a data group that includes one or more, or in some cases two or more, children.

For example, a first shape may be defined by first determining a lowest (or most nested) hierarchical level of a data group. A data group that includes child data but does not include grandchild data (i.e., where the child data groups do not contain children of their own) may define a first shape. As a particular example and with reference to the document data of Appendix 1, an identification of shapes within the document data may begin at highest hierarchical data group level and may navigate children until a level is reached that has no grandchildren. Beginning on the first page of the document data, this may proceed, according to at least one embodiment, as follows: OrderAcks→OrderAck→Header→OrderHeader. That is, beginning with the first group of data (OrderAcks in this case), the structural data hierarchy may be followed until reaching a data group that contains child data but does not contain grandchild data. The OrderHeader group of data contains seven children (i.e., TradingPartnerID, PurchaseOrderNumber, TsetPurposeCode, PurchaseOrderDate, AcknowledgementType, AcknowledgementDate, and Vendor), but does not contain grandchildren. That is, none of the TradingPartnerID, PurchaseOrderNumber, TsetPurposeCode, PurchaseOrderDate, AcknowledgementType, AcknowledgementDate, or Vendor data items contain children of their own. It may thus be determined that this data group defines a first shape, as shown in Appendix 2 (OrderHeader=Shape 1). Sibling data groups at the same hierarchical level may be examined to define shapes as well. That is, within the Header data group, the data group for Address is a sibling to the data group OrderHeader. (OrderAcks→OrderAck→Header→Address). The Address data group contains nine children (i.e., AddressTypeCode, LocationCodeQualifier, AddressLocationNumber, AddressName, Address1, City, State, PostalCode, and Country), but does not contain grandchild data. It may thus be determined that this data set defines a second shape, as shown in Appendix 2 (Address=Shape 2).

Upon identifying shapes at one hierarchical level of the document data, a next level of the data hierarchy may be examined to define additional shapes. For example, and with continued reference to Appendix 1, OrderHeader (which also defines Shape 1) and Address (which also defines Shape 2) are both children of the Header data group. A third shape may thus be defined to include both the first and second shapes (Shapes 1 and 2), as shown in Appendix 2 (Header =Shape 3, which includes, as children, the hash identifiers of Shapes 1 and 2). Proceeding within the same hierarchical level as Header, LineItems is a sibling data group to Header. Additional shapes may be determined by examining data items within LineItems of a “lowest” or most nested hierarchical level. In particular, ProductID is a data group with two children (i.e., PartNumberQual and PartNumber), but that does not contain grandchildren. Thus, a fourth shape may be determined to include this data group (ProductID=Shape 4). Moving to a next hierarchical level within LineItems, each of OrderLine, LineItemAcknowledgement, and ProductOrItemDescription may define a shape (Shapes 5, 6, and 7, respectively). As shown in Appendix 2, the hierarchical structure of the document data may be followed to continue defining shapes as including child data. Data shapes within document data may thus be defined based upon a hierarchical structure of the data. However, it is to be appreciated that in other embodiments, data shapes may be defined using different methodologies and/or may group together data fields, qualifiers, and/or other data items differently to form shapes. Also, while one example order of navigating through the data of Appendix 1 to obtain the shapes (e.g., Shapes 1, 2, 3, etc.) provided as examples in Appendix 2 has been described, any other suitable order of defining shapes based on a hierarchical structure of the data may be used and is not intended to be limited by the example described herein.

Referring back to FIG. 5, an identifier may be assigned to each data shape 506. The identifier may be a unique numerical or alphanumeric hash value, for example. Moreover, each of the identifiers and the associated elements that define the shape may be stored 508 in a database of shape information. For example, each shape identifier may be stored, together with the structural particulars of the shape including fields and qualifiers that define the shape. Additionally, in some embodiments, a list of shape identifiers associated with the first document data may be stored in a database. In this way, an administrator may have the ability to determine from the stored data which shapes are associated with which documents and vice-a-versa. Shape identifiers and shape structural particulars may be stored on non-transitory computer readable storage media.

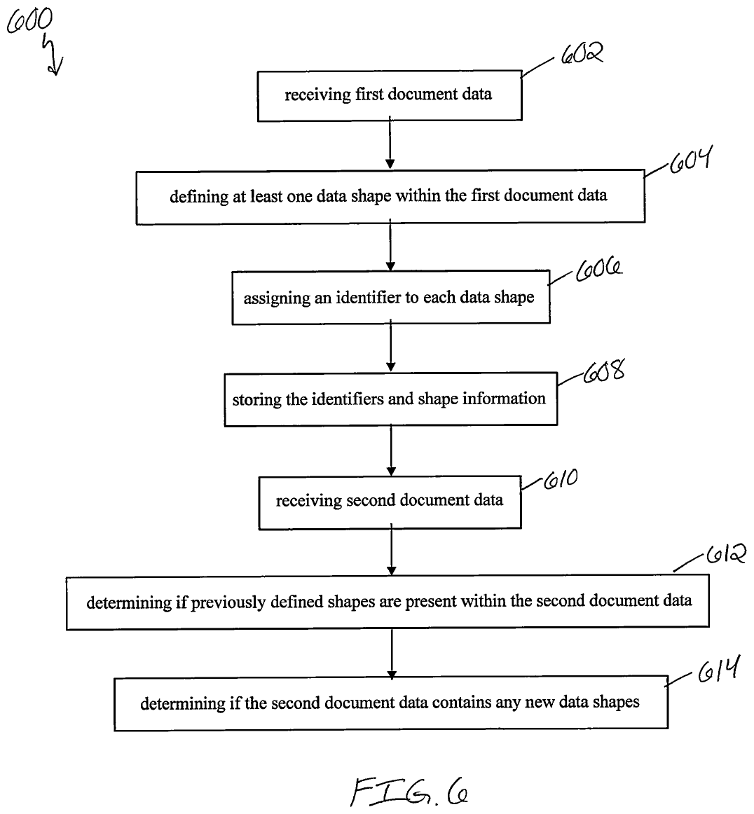

In some embodiments, document data may be analyzed to determine if it includes previously defined shapes. For example, FIG. 6 shows another method 600 of data analysis according to one or more embodiments. As shown, the method 600 may generally include receiving first document data 602, defining at least one data shape within the first document data 604, assigning an identifier to each data shape 606, and storing each of the identifiers and associated shape information 608. Steps 602-608 may be generally similar to steps 502-508 described above with respect to FIG. 5. However, the method 600 may additionally include the steps of receiving second document data 610, determining previously defined shapes are present within the second document data 612, and determining if the second document data contains any new data shapes 614. In other embodiments, the method 600 may include additional and/or alternative steps.

With respect to receiving second document data 610, the second document data may relate to a different document, transaction, and/or parcel than the first document data. In some embodiments, the second document data may relate to a same transaction or document as the first document data, but a different parcel. The second document data may be received in a same or different format as the first document data and/or from a same or different source.

The second document data may be examined to determine if any previously defined shapes, for example identified from the first document data, are present in the second document data 612. This may include identifying the fields and field qualifiers of the second document data to determine if any grouping of fields within the second document data is reflective of a previously defined shape. This may indicate that the second document data contains structural elements that were also present in previously received document data.

The second document data may additionally be examined to determine if there are any additional or new data shapes present in the second document data that have not otherwise been identified using previously identified shapes 614. That is, the second document data may be analyzed to determine if there are new data shapes that may be assigned new identifiers. This may indicate that the second document data includes different and/or additional structural elements as compared with previously received document data. Identifiers for any new shapes and the corresponding shape information may be stored in the database.

Grouping document structural components into defined shapes in accordance with the present disclosure may provide insights into the data flows and associated transactions. For example, structural commonalities or differences may be readily identified based on whether two sets of data contain any of the same data shapes. This may help to readily identify, for example, if a document or document format is deficient in some way.

For example, data shapes may be used in regression testing of document data. As a particular example, a vendor in a retail ecosystem network may have particular requirements for documents issued to the vendor from other trading partners in the network. The requirements may include the presence or absence of particular fields or types of data, or the use of particular field qualifiers. Data shapes may be used to determine whether trading partners are complying with the vendor's document requirements. That is, rather than searching or examining individual documents sent from the various trading partners to the vendor, data shapes associated with the documents may be reviewed or searched more easily to determine if the trading partners' documents are meeting the vendor's requirements. Shapes may further be used to determine which, if any, of the trading partners are not meeting the requirements. As another example of regression testing, if a vendor in a retail ecosystem seeks to make a change to its document requirements, shapes may be used to determine which trading partners would be affected by the new change. As a particular example, if a vendor determines that purchase orders received from all trading partners going forward should include a “shipping address” field in addition to a “company address” field, shapes may be used to determine which trading partners' purchase orders already include both fields, and which trading partners' purchase orders only include a company address field, or otherwise only include a single address field or do not include a shipping address. Such information may help to determine which trading partners need to be made aware of the vendor's new address field requirements.

Shapes may additionally help to streamline onboarding of new vendors, retailers, or other trading partners. For example, shapes may be used to analyze the data structure that a particular retailer requires from its vendors in practice. As a new vendor enters the network, those shapes may be used to help ensure that the new vendor is prepared to meet the requirements for the retailer. This may help save time in determining the data structure that retailers use in practice and may streamline the new vendor's effort in tailoring document structures. This may, in turn, reduce the amount of testing needed to ensure the new vendor is compliant.

As another example, shapes may be used to determine trends or common structures throughout the network or among particular trading partners or other entities. Such trends or commonalities may be used to create standard or canonical document formats reflective of trends within the network. In particular, a standard or canonical document format may be defined with structure that includes the most frequent data shapes repeated with respect to a particular document type, vendor, retailer, or with respect to the network as a whole. Such standard or canonical document formats may be particularly helpful for new trading partners entering the network.

It is to be appreciated that systems and methods described herein may improve the functioning of a computer, computer components, and/or processes performed on or using a computer or computer components. In general, the systems and methods described herein may increase the efficiency, accuracy, and speed with which document data or transaction data may be viewed, tracked, and/or analyzed. For example, the use of data shapes may allow information about document data structure to be stored in the form of hash identifiers or other identifiers, which may take up significantly less storage space and be more concise than the document data itself. Such hash identifiers may be readily searched, aggregated, and/or compared in a more efficient, less time-consuming, and less bandwidth-intensive way than can be performed using raw document data, such as XML data or other document or transaction data, thus improving the functioning of the computer, components, and/or computer processes themselves.

For purposes of this disclosure, any system described herein may include, and any method described herein may be performed using a system that includes, any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR, Bluetooth, or other wireless interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

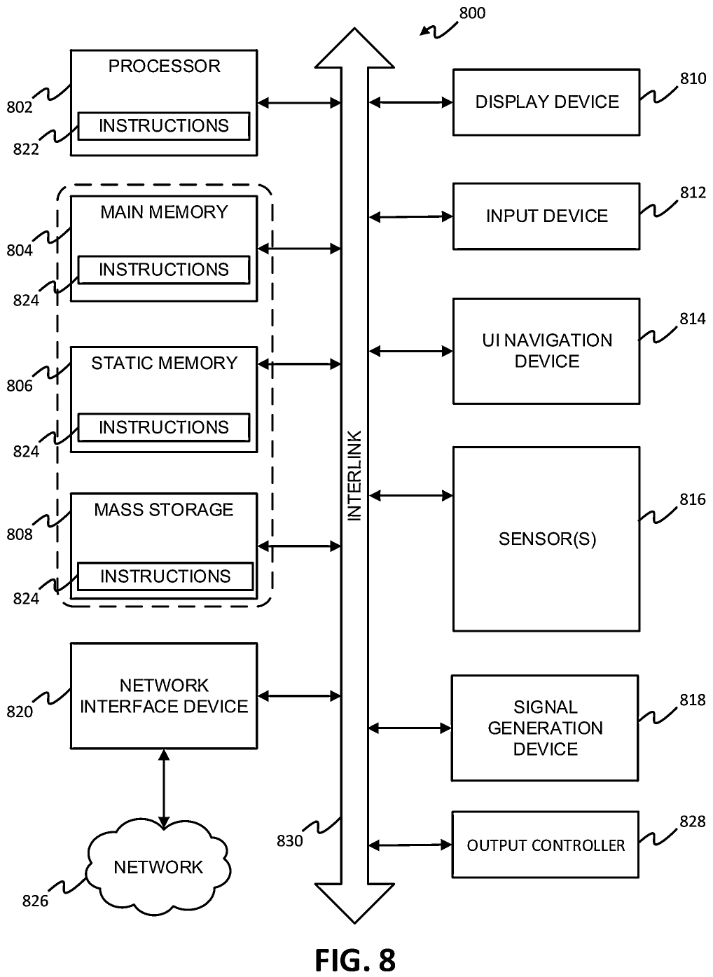

FIG. 8 illustrates a more specific example and block diagram schematic of various example components of an example machine 800 upon which any one or more of the techniques or methodologies discussed herein may perform. Examples, as described herein, can include, or can operate by, logic or a number of components, or mechanisms in machine 800. Machine 800 can operate as a standalone device or can be connected (e.g., networked) to other machines. In a networked deployment, machine 800 can operate in the capacity of a server machine, a client machine, or both in server-client network environments. In some examples, machine 800 can act as a peer machine in a peer-to-peer (P2P) (or other distributed) network environment. Machine 800 can be or include a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 800 can include a hardware processor 802 (e.g., a central processing unit (CPU), a graphics processing unit (GPU), a hardware processor core, or any combination thereof) and a main memory 804, a static memory (e.g., memory or storage for firmware, microcode, a basic-input-output (BIOS), unified extensible firmware interface (UEFI), etc.) 806, and/or mass storage 808 (e.g., hard drives, tape drives, flash storage, or other block devices) some or all of which can communicate with each other via an interlink (e.g., bus) 830. Machine 800 can further include a display device 810 and an input device 812 and/or a user interface (UI) navigation device 814. Example input devices and UI navigation devices include, without limitation, one or more buttons, a keyboard, a touch-sensitive surface, a stylus, a camera, a microphone, etc.). In some examples, one or more of the display device 810, input device 812, and UI navigation device 814 can be a combined unit, such as a touch screen display. Machine 800 can additionally include a signal generation device 818 (e.g., a speaker), a network interface device 820, and one or more sensors 816, such as a global positioning system (GPS) sensor, compass, accelerometer, or other sensor. Machine 800 can include an output controller 828, such as a serial (e.g., universal serial bus (USB), parallel, or other wired or wireless (e.g., infrared (IR), NFC, etc.) connection to communicate or control one or more peripheral devices (e.g., a printer, card reader, etc.).

Processor 802 can correspond to one or more computer processing devices or resources. For instance, processor 802 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 802 can be provided as a microprocessor, Central Processing Unit (CPU), or plurality of microprocessors or CPUs that are configured to execute instructions sets stored in an internal memory 822 and/or memory 804, 806, 808.

Any of memory 804, 806, and 808 can be used in connection with the execution of application programming or instructions by processor 802, and for the temporary or long-term storage of program instructions or instruction sets 824 and/or other data. Any of memory 804, 806, 808 can comprise a computer readable medium that can be any medium that can contain, store, communicate, or transport data, program code, or instructions 824 for use by or in connection with machine 800. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), a solid-state storage device, in general, a compact disc read-only memory (CD-ROM), or other optical or magnetic storage device. As noted above, computer readable media includes, but is not to be confused with, computer readable storage media, which is intended to cover all physical, non-transitory, or similar embodiments of computer readable media.

Network interface device 820 includes hardware to facilitate communications with other devices over a communication network 826, utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi, IEEE 802.16 family of standards known as WiMax), IEEE 802.15.4 family of standards, and peer-to-peer (P2P) networks, among others. In some examples, network interface device 720 can include an Ethernet port or other physical jack, a Wi-Fi card, a Network Interface Card (NIC), a cellular interface (e.g., antenna, filters, and associated circuitry), or the like. In some examples, network interface device 820 can include a plurality of antennas to wirelessly communicate using at least one of single-input multiple-output (SIMO), multiple-input multiple-output (MIMO), or multiple-input single-output (MISO) techniques.

As indicated above, machine 800 can include one or more interlinks or buses 830 operable to transmit communications between the various hardware components of the machine. A system bus 830 can be any of several types of commercially available bus structures or bus architectures.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, unless otherwise stated or clear from the context of the specification, as used herein, the phrases “at least one of [X] and [Y]” or “at least one of [X] or [Y],” where X and Y are different components that may be included in an embodiment of the present disclosure, mean that the embodiment could include component X without component Y, the embodiment could include the component Y without component X, or the embodiment could include both components X and Y. Similarly, when used with respect to three or more components, such as “at least one of [X], [Y], and [Z]” or “at least one of [X], [Y], or [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

```
APPENDIX 1
<?xml version=″1.0″ encoding=″utf-8″?>
<OrderAcks xmlns=″http://www.spscommerce.com/RSX″>
<OrderAck>
<Header>
  <OrderHeader>
    <TradingPartnerId>SIMMONS</TradingPartnerId>
    <PurchaseOrderNumber>P000904304</PurchaseOrderNumber>
    <TsetPurposeCode>00</TsetPurposeCode>
    <PurchaseOrderDate>2018-10-02</PurchaseOrderDate>
    <AcknowledgementType>AK</AcknowledgementType>
    <AcknowledgementDate>2018-10-02</AcknowledgementDate>
    <Vendor>SIMMONS</Vendor>
  </OrderHeader>
  <Address>
    <AddressTypeCode>ST</AddressTypeCode>
    <LocationCodeQualifier>92</LocationCodeQualifier>
    <AddressLocationNumber>061800</AddressLocationNumber>
    <AddressName>Virginia Beach Main Warehouse</AddressName>
    <Address1>713 Fenway Avenue Ste B</Address1>
    <City>Chesapeake</City>
    <State>VA</State>
    <PostalCode>23323</PostalCode>
    <Country>USA</Country>
    </Address>
</Header>
<LineItems>
  <LineItem>
    <OrderLine>
      <LineSequenceNumber>1</LineSequenceNumber>
      <BuyerPartNumber>V000063716</BuyerPartNumber>
      <VendorPartNumber>700700123-1050</VendorPartNumber>
      <ProductID>
        <PartNumberQual>MI</PartNumberQual>
        <PartNumber>113032</PartNumber>
      </ProductID>
      <OrderQty>6</OrderQty>
      <OrderQtyUOM>EA</OrderQtyUOM>
      <PurchasePrice>315</PurchasePrice>
    </OrderLine>
    <LineItemAcknowledgement>
      <ItemStatusCode>IA</ItemStatusCode>
      <ItemScheduleQty>6</ItemScheduleQty>
      <ItemScheduleUOM>EA</ItemScheduleUOM>
      <ItemScheduleQualifier>068</ItemScheduleQualifier>
      <ItemScheduleDate>2018-10-05</ItemScheduleDate>
    </LineItemAcknowledgement>
    <ProductOrItemDescription>
      <ItemDescriptionType>08</ItemDescriptionType>
      <ProductDescription>HARTFIELD LUXURY
      FIRM MATT</ProductDescription>
    </ProductOrItemDescription>
  </LineItem>
  <LineItem>
    <OrderLine>
      <LineSequenceNumber>2</LineSequenceNumber>
      <BuyerPartNumber>V000063715</BuyerPartNumber>
      <VendorPartNumber>700700123-1030</VendorPartNumber>
      <ProductID>
        <PartNumberQual>MI</PartNumberQual>
        <PartNumber>113032</PartNumber>
      </ProductID>
      <OrderQty>6</OrderQty>
      <OrderQtyUOM>EA</OrderQtyUOM>
      <PurchasePrice>296</PurchasePrice>
    </OrderLine>
    <LineItemAcknowledgement>
      <ItemStatusCode>IA</ItemStatusCode>
      <ItemScheduleQty>6</ItemScheduleQty>
      <IemScheduleUOM>EA</ItemScheduleUOM>
      <ItemScheduleQualifier>068</ItemScheduleQualifier>
      <ItemScheduleDate>2018-10-05</ItemScheduleDate>
    </LineItemAcknowledgement>
    <ProductOrItemDescription>
      <ItemDescriptionType>08</ItemDescriptionType>
      <ProductDescription>HARTFIELD LUXURY
      FIRM MATT</ProductDescription>
    </ProductOrItemDescription>
  </LineItem>
</LineItems>
<Summary>
  <TotalLineItemNumber>2</TotalLineItemNumber>
</Summary>
</OrderAck>
</OrderAcks>
```

```
APPENDIX 2
{
  ″Shape 1″: {
    ″hash_id″: ″bf617844799e2312115320b0976c7c3255d
8382627d98d3f822f6a0c77a9391b″,
    ″name″: ″OrderHeader″,
    ″children″: [
      {
        ″name″: ″TradingPartnerId″,
        ″type″: ″String″,
        ″qualifier″: ″ ″
      },
      {
        ″name″: ″PurchaseOrderNumber″,
        ″type″: ″String″,
        ″qualifier″: ″ ″
      },
      {
        ″name″: ″TsetPurposeCode″,
        ″type″: ″StringSet″,
        ″qualifier″: ″00″
      },
      {
        ″name″: ″PurchaseOrderDate″,
        ″type″: ″Date″,
        ″qualifier″: ″ ″
      },
      {
        ″name″: ″AcknowledgementType″,
        ″type″: ″StringSet″,
        ″qualifier″: ″AK″
      },
      {
        ″name″: ″AcknowledgementDate″,
        ″type″: ″Date″,
        ″qualifier″: ″ ″
      },
      {
        ″name″: ″Vendor″,
        ″type″: ″String″,
        ″qualifier″: ″ ″
      }
    ]
  },
  ″Shape 2″: {
    ″hash_id″: ″9125371f81b8480d3496f6748393383a92bb
05185b533cf91571da49abae859d″,
    ″name″: ″Address″,
    ″children″: [
      {
        ″name″: ″AddressTypeCode″,
        ″type″: ″StringSet″,
        ″qualifier″: ″ST″
      },
      {
        ″name″: ″LocationCodeQualifier″,
        ″type″: ″StringSet″,
        ″qualifier″: ″92″
      },
      {
        ″name″: ″AddressLocationNumber″,
        ″type″: ″String″,
        ″qualifier″: ″ ″
      },
      {
        ″name″: ″AddressName″,
        ″type″: ″String″,
        ″qualifier″: ″ ″
      },
      {
        ″name″: ″Address1″,
        ″type″: ″String″,
        ″qualifier″: ″ ″
      },
      {
        ″name″: ″City″,
        ″type″: ″String″,
        ″qualifier″: ″ ″
      },
      {
        ″name″: ″State″,
        ″type″: ″String″,
        ″qualifier″: ″ ″
      },
      {
        ″name″: ″PostalCode″,
        ″type″: ″String″,
        ″qualifier″: ″ ″
      },
      {
        ″name″: ″Country″,
        ″type″: ″String″,
        ″qualifier″: ″ ″
      }
    ]
  },
  ″Shape 3″: {
    ″hash_id″: ″1138111add72b054833b60c778b39d8ebe6a76b
7f313377a02a33c0397e7ca10″,
    ″name″: ″Header″,
    ″children″: [
      {
        ″hash_id″: bf617844799e2312115320b0976c7c3255d
8382627d98d3f822f6a0c77a9391b″,
        ″child_count″: 1
      },
      {
        ″hash_id″: 9125371f81b8480d3496f6748393383a92bb
05185b533cf91571da49abae859d″,
        ″child_count″: 1
      }
    ]
  },
  ″Shape 4″: {
    ″hash_id″: ″47cfe7a98f3fa08a208adf6b6e7d6b8d19889ff
57878520a9580177c63cdcf0c″,
    ″name″: ″ProductID″,
    ″children″: [
      {
        ″name″: ″PartNumberQual″,
        ″type″: ″StringSet″,
        ″qualifier″: ″MI″
      },
      {
        ″name″: ″PartNumber″,
        ″type″: ″String″,
        ″qualifier″: ″ ″
      }
    ]
  },
  ″Shape 5″: {
    ″hash_id″: ″7339e7d00efedf431f6f578d84edebb06bf0f08d1a
555e8071382209419ae4cc″,
    ″name″: ″OrderLine″,
    ″children″: [
      {
        ″name″: ″LineSequenceNumber″,
        ″type″: ″String″,
        ″qualifier″: ″ ″
      },
      {
        ″name″: ″BuyerPartNumber″,
        ″type″: ″String″,
        ″qualifier″: ″ ″
      },
      {
        ″name″: ″VendorPartNumber″,
        ″type″: ″String″,
        ″qualifier″: ″ ″
      },
      {
        ″hash_id″: ″47cfe7a98f3fa08a208adf6b6e7d6b8d19889ff
57878520a9580177c63cdcf0c,
        ″child_count″: 1
      },
      {
        ″name″: ″OrderQty″,
        ″type″: ″Decimal″,
        ″qualifier″: ″ ″
      },
      {
        ″name″: ″OrderQtyUOM″,
        ″type″: ″StringSet″,
        ″qualifier″: ″EA″
      },
      {
        ″name″: ″PurchasePrice″,
        ″type″: ″Decimal″,
        ″qualifier″: ″ ″
      }
    ]
  },
  ″Shape 6″: {
    ″hash_id″: ″94ad5356e9d7ded23d4b367c18ce8a35e3ab597b
2f4d580782a548328ed7cd10″,
    ″name″: ″LineItemAcknowledgement″,
    ″children″: [
      {
        ″name″: ″ItemStatusCode″,
        ″type″: ″StringSet″,
        ″qualifier″: ″IA″
      },
      {
        ″name″: ″ItemScheduleQty″,
        ″type″: ″String″,
        ″qualifier″: ″ ″
      },
      {
        ″name″: ″ItemScheduleUOM″,
        ″type″: ″StringSet″,
        ″qualifier″: ″EA″
      },
      {
        ″name″: ″ItemScheduleQualifier″,
        ″type″: ″StringSet″,
        ″qualifier″: ″068″
      },
      {
        ″name″: ″ItemScheduleDate″,
        ″type″: ″Date″,
        ″qualifier″: ″ ″
      }
    ]
  },
  ″Shape 7″: {
    ″hash_id″: ″b6dcf209bf21c13f658fc008bbf3478a89a70ecd
846870817efaeae82b10d41a″,
    ″name″: ″ProductOrItemDescription″,
    ″children″: [
      {
        ″name″: ″ItemDescriptionType″,
        ″type″: ″StringSet″,
        ″qualifier″: ″08″
      },
      {
        ″name″: ″ProductDescription″,
        ″type″: ″String″,
        ″qualifier″: ″ ″
      }
    ]
  },
  ″Shape 8″: {
    ″hash_id″: ″db40f91bb5294e0875c972fe86ec08c9b00711864aa
58a9d7c6915823fa76245″,
    ″name″: ″LineItem″,
    ″children″: [
      }
        ″hash_id″: ″7339e7d00efedf431f6f578d84edebb06bf0f08d1a
555e8071382209419ae4cc″,
        ″child_count″: 1
      },
      {
        ″hash_id″: ″94ad5356e9d7ded23d4b367c18ce8a35e3ab597b2f
4d580782a548328ed7cd10″,
        ″child_count″: 1
      },
      {
        ″hash_id″: ″b6dcf209bf21c13f658fc008bbf3478a89a70ecd
846870817efaeae82b10d41a″,
        ″child_count″: 1
      }
    ]
  },
  ″Shape 9″: {
    ″hash_id″: ″4b4cb3558e8628105e3582252c6a52f3c5ccfe04135ee
22c58d1439593ce402e″,
    ″name″: ″LineItems″,
    ″children″: [
      {
        ″hash_id″: ″db40f91bb5294e0875c972fe86ec08c9b
00711864aa58a9d7c6915823fa76245″,
        ″child_count″: 2
      }
    ]
  },
  ″Shape 10″: {
    ″hash_id″: ″5b300c0d53c2f5ca56d5be779606879876194d
7b2e0282c3eb4dfa494b733f42″,
    ″name″: ″Summary″,
    ″children″: [
      {
        ″name″: ″TotalLineItemNumber″,
        ″type″: ″Integer″,
        ″qualifier″: ″ ″
      }
    ]
  },
  ″Shape 11″: {
    ″hash_id″: ″a804df463cde590fa695dbf00a3edb4cc9212e625bb
4340c015f63dc37bc1856″,
    ″name″: ″OrderAck″,
    ″children″: [
      {
        ″hash_id″: ″1138111add72b054833b60c778b39d8ebe6a76b7f
313377a02a33c0397e7ca10″,
        ″child_count″: 1
      },
      {
        ″hash_id″: ″4b4cb3558e8628105e3582252c6a52f3c5ccfe
04135ee22c58d1439593ce402e″,
        ″child_count″: 1
      },
      {
        ″hash_id″: ″5b300c0d53c2f5ca56d5be779606879876194d7b2e
0282c3eb4dfa494b733f42″,
        ″child_count″: 1
      }
    ]
  },
  ″Shape 12″: {
    ″hash_id″: ″dc968b924dbd66586527250d22e16ab020b5c
223649ae9989be4f9afea16d2bb″,
    ″name″: ″OrderAcks″,
    ″children″: [
      {
        ″hash_id″: ″a804df463cde590fa695dbf00a3edb4cc9212e
625bb4340c015f63dc37bc1856″,
        ″child_count″: 1
      }
    ]
  }
}
```

```
APPENDIX 3
<?xml version=″1.0″ encoding=″utf-8″?>
<OrderAcks xmlns=″http://www.spscommerce.com/RSX″>
<OrderAck>
  <Header>
    <OrderHeader>
      <TradingPartnerId>SIMMONS</TradingPartnerId>
      <PurchaseOrderNumber>P000912544</PurchaseOrderNumber>
      <IsetPurposeCode>00</TsetPurposeCode>
      <PurchaseOrderDate>2018-10-08</PurchaseOrderDate>
      <AcknowledgementType>AK</AcknowledgementType>
      <AcknowledgementDate>2018-10-08</AcknowledgementDate>
      <Vendor>SIMMONS</Vendor>
    </OrderHeader>
    <Address>
      <AddressTypeCode>ST</AddressTypeCode>
      <LocationCodeQualifier>92</LocationCodeQualifier>
      <AddressLocationNumber>502000</AddressLocationNumber>
      <AddressName>Oakland Main Warehouse</AddressName>
      <Address1>650 85th Ave</Address1>
      <City>Oakland</City>
      <State>CA</State>
      <PostalCode>94621</PostalCode>
      <Country>USA</Country>
    </Address>
  </Header>
  <LineItems>
    <LineItem>
      <OrderLine>
        <LineSequenceNumber>1</LineSequenceNumber>
        <BuyerPartNumber>V000110047</BuyerPartNumber>
        <VendorPartNumber>700754372-6050</VendorPartNumber>
        <ProductID>
          <PartNumberQual>MI</PartNumberQual>
          <PartNumber>126483</PartNumber>
        </ProductID>
        <OrderQty>6</OrderQtY>
        <OrderQtyUOM>EA</OrderQtyUOM>
        <PurchasePrice>122</PurchasePrice>
      </OrderLine>
      <LineItemAcknowledgement>
        <ItemStatusCode>IA</ItemStatusCode>
        <ItemScheduleQty>6</ItemScheduleQty>
        <ItemScheduleUOM>EA</ItemScheduleUOM>
        <ItemScheduleQualifier>068</ItemScheduleQualifier>
        <ItemScheduleDate>2018-10-11</ItemScheduleDate>
      </LineItemAcknowledgement>
      <ProductOrItemDescription>
        <ItemDescriptionType>08</ItemDescriptionType>
        <ProductDescription>2018 PLATINUM
        FND</ProductDescription>
      </ProductOrItemDescription>
    </LineItem>
    <LineItem>
      <OrderLine>
        <LineSequenceNumber>2</LineSequenceNumber>
        <BuyerPartNumber>V000084552</BuyerPartNumber>
        <VendorPartNumber>700752526-1050</VendorPartNumber>
        <ProductID>
          <PartNumberQual>MR/PartNumberQual>
          <PartNumber>118041</PartNumber>
        </ProductID>
        <OrderQty>6</OrderQtY>
        <OrderQtyUOM>EA</OrderQtyUOM>
        <PurchasePrice>1235</PurchasePrice>
      </OrderLine>
      <LineItemAcknowledgement>
        <ItemStatusCode>IA</ItemStatusCode>
        <ItemScheduleQty>6</ItemScheduleQty>
        <ItemScheduleUOM>EA</ItemScheduleUOM>
        <ItemScheduleQualifier>068</ItemScheduleQualifier>
        <ItemScheduleDate>2018-10-11</ItemScheduleDate>
      </LineItemAcknowledgement>
      <ProductOrItemDescription>
        <ItemDescriptionType>08</ItemDescriptionTYPe>
        <ProductDescription>WINWARD LUXURY FIRM LEGENDS
MATT</ProductDescription>
      </ProductOrItemDescription>
    </LineItem>
  </LineItems>
  <Summary>
    <TotalLineItemNumber>2</TotalLineItemNumber>
  </Summary>
</OrderAck>
</OrderAcks>
```

```
APPENDIX 4
<?xml version=″1.0″ encoding=″utf-8″?>
<OrderAcks xmlns=″http://www.spscommerce.com/RSX″>
<OrderAck>
  <Header>
      <OrderHeader>
      <TradingPartnerId>Test partner id</TradingPartnerId>
      <PurchaseOrderNumber>012345</PurchaseOrderNumber>
      <TsetPurposeCode>00</TsetPurposeCode>
      <PurchaseOrderDate>No Date here</PurchaseOrderDate>
      <AcknowledgementType>AK</AcknowledgementType>
      <AcknowledgementDate>No Date here
      either</AcknowledgementDate>
      <Vendor>SIMMONS</Vendor>
    </OrderHeader>
    <Address>
      <AddressTypeCode>ST</AddressTypeCode>
      <LocationCodeQualifier>92</LocationCodeQualifier>
      <AddressLocationNumber>061800</AddressLocationNumber>
      <AddressName>Virginia Beach Main Warehouse</AddressName>
      <Address1>713 Fenway Avenue Ste B</Address1>
      <City>Chesapeake</City>
      <State>VA</State>
      <PostalCode>23323</PostalCode>
      <Country>USA</Country>
    </Address>
  </Header>
  <LineItems>
    <LineItem>
      <OrderLine>
        <LineSequenceNumber>1</LineSequenceNumber>
        <BuyerPartNumber>V000063716</BuyerPartNumber>
        <VendorPartNumber>700700123-1050</VendorPartNumber>
        <ProductID>
          <PartNumberQual>MI</PartNumberQual>
          <PartNumber>113032</PartNumber>
        </ProductID>
        <OrderQty>6</OrderQty>
        <OrderQtyUOM>EA</OrderQtyUOM>
        <PurchasePrice>315</PurchasePrice>
      </OrderLine>
      <LineItemAcknowledgement>
        <ItemStatusCode>IA</ItemStatusCode>
        <ItemScheduleQty>6</ItemScheduleQty>
        <ItemScheduleUOM>EA</ItemScheduleUOM>
        <ItemScheduleQualifier>068</ItemScheduleQualifier>
        <ItemScheduleDate>2018-10-05</ItemScheduleDate>
      </LineItemAcknowledgement>
      <ProductOrItemDescription>
        <ItemDescriptionType>08</ItemDescriptionType>
        <ProductDescription>HARTFIELD LUXURY FIRM
MATT</ProductDescription>
      </ProductOrItemDescription>
    </LineItem>
  </LineItems>
  <Summary>
      <TotalLineItemNumber>2</TotalLineItemNumber>
  </Summary>
</OrderAck>
</OrderAcks>
```

```
APPENDIX 5
{
  ″Shape 1″: {
    ″hash_id″: ″bf617844799e2312115320b0976c7c3255d8382627d
98d3f822f6a0c77a9391b″,
    ″name″: ″OrderHeader″,
    ″children″: [
      {
        ″name″: ″TradingPartnerId″,
        ″type″: ″String″,
        ″qualifier″: ″ ″
      },
      {
        ″name″: ″PurchaseOrderNumber″,
        ″type″: ″String″,
        ″qualifier″: ″ ″
      },
      {
        ″name″: ″TsetPurposeCode″,
        ″type″: ″StringSet″,
        ″qualifier″: ″00″
      },
      {
        ″name″: ″PurchaseOrderDate″,
        ″type″: ″Date″,
        ″qualifier″: ″ ″
      },
      {
        ″name″: ″AcknowledgementType″,
        ″type″: ″StringSet″,
        ″qualifier″: ″AK″
      },
      {
        ″name″: ″AcknowledgementDate″,
        ″type″: ″Date″,
        ″qualifier″: ″ ″
      },
      {
        ″name″: ″Vendor″,
        ″type″: ″String″,
        ″qualifier″: ″ ″
      }
    ]
  },
  ″Shape 2″: {
    ″hash_id″: ″9125371f81b8480d3496f6748393383a92bb05185b
533cf91571da49abae859d″,
    ″name″: ″Address″,
    ″children″: [
      {
        ″name″: ″AddressTypeCode″,
        ″type″: ″StringSet″,
        ″qualifier″: ″ST″
      },
      {
        ″name″: ″LocationCodeQualifier″,
        ″type″: ″StringSet″,
        ″qualifier″: ″92″
      },
      {
        ″name″: ″AddressLocationNumber″,
        ″type″: ″String″,
        ″qualifier″: ″ ″
      },
      {
        ″name″: ″AddressName″,
        ″type″: ″String″,
        ″qualifier″: ″ ″
      },
      {
        ″name″: ″Address1″,
        ″type″: ″String″,
        ″qualifier″: ″ ″
      },
      {
        ″name″: ″City″,
        ″type″: ″String″,
        ″qualifier″: ″ ″
      },
      {
        ″name″: ″State″,
        ″type″: ″String″,
        ″qualifier″: ″ ″
      },
      {
        ″name″: ″PostalCode″,
        ″type″: ″String″,
        ″qualifier″: ″ ″
      },
      {
        ″name″: ″Country″,
        ″type″: ″String″,
        ″qualifier″: ″ ″
      }
    ]
  },
  ″Shape 3″: {
    ″hash_id″: ″1138111add72b054833b60c778b39d8ebe6a76b7f
313377a02a33c0397e7ca10″,
    ″name″: ″Header″,
    ″children″: [
      {
        ″hash_id″: ″bf617844799e2312115320b0976c7c3255d
8382627d98d3f822f6a0c77a9391b″,
        ″child_count″: 1
      },
      {
          ″hash_id″: ″9125371f81b8480d3496f6748393383a92
bb05185b533cf91571da49abae859d″,
        ″child_count″: 1
      }
    ]
  },
  ″Shape 4″: {
    ″hash_id″: ″47cfe7a98f3fa08a208adf6b6e7d6b8d19889ff
57878520a9580177c63cdcf0c″,
    ″name″: ″ProductID″,
    ″children″: [
      {
        ″name″: ″PartNumberQual″,
        ″type″: ″StringSet″,
        ″qualifier″: ″MI″
      },
      {
        ″name″: ″PartNumber″,
        ″type″: ″String″,
        ″qualifier″: ″ ″
      }
    ]
  },
  ″Shape 5″; {
    ″hash_id″: ″7339e7d00efedf431f6f578d84edebb06bf0f08d1a555e
8071382209419ae4cc″,
    ″name″: ″OrderLine″,
    ″children″: [
      {
        ″name″: ″LineSequenceNumber″,
        ″type″: ″String″,
        ″qualifier″: ″ ″
      },
      {
        ″name″: ″BuyerPartNumber″,
        ″type″: ″String″,
        ″qualifier″: ″ ″
      },
      {
        ″name″: ″VendorPartNumber″,
        ″type″: ″String″,
        ″qualifier″: ″ ″
      },
      {
        ″hash_id″: ″47cfe7a98f3fa08a208adf6b6e7d6b8d19889ff
57878520a9580177c63cdcf0C″,
        ″child_count″: 1
      },
      }
        ″name″: ″OrderQty″,
        ″type″: ″Decimal″,
        ″qualifier″: ″ ″
      },
      {
        ″name″: ″OrderQtyUOM″,
        ″type″: ″StringSet″,
        ″qualifier″: ″EA″
      },
      {
        ″name″: ″PurchasePrice″,
        ″type″: ″Decimal″,
        ″qualifier″: ″ ″
      }
    ]
  },
  ″Shape 6″: {
    ″hash_id″: ″94ad5356e9d7ded23d4b367c18ce8a35e3ab597b2f4d
580782a548328ed7cd10″,
    ″name″: ″LineItemAcknowledgement″,
    ″children″: [
      {
        ″name″: ″ItemStatusCode″,
        ″type″: ″StringSet″,
        ″qualifier″: ″IA″
      },
      {
        ″name″: ″ItemScheduleQty″,
        ″type″: ″String″,
        ″qualifier″: ″ ″
      },
      {
        ″name″: ″ItemScheduleUOM″,
        ″type″: ″StringSet″,
        ″qualifier″: ″EA″
      },
      {
        ″name″: ″ItemScheduleQualifier″,
        ″type″: ″StringSet″,
        ″qualifier″: ″068″
      },
      {
        ″name″: ″ItemScheduleDate″,
        ″type″: ″Date″,
        ″qualifier″: ″ ″
      }
    ]
  },
  ″Shape 7″: {
    ″hash_id″: ″b6dcf209bf21c13f658fc008bbf3478a89a70ecd
846870817efaeae82b10d41a″,
    ″name″: ″ProductOrItemDescription″,
    ″children″: [
      {
        ″name″: ″ItemDescriptionType″,
        ″type″: ″StringSet″,
        ″qualifier″: ″08″
      },
      {
        ″name″: ″ProductDescription″,
        ″type″: ″String″,
        ″qualifier″: ″ ″
      }
    ]
  },
  ″Shape 8″: {
    ″hash_id″: ″db40f91bb5294e0875c972fe86ec08c9b00711864aa
58a9d7c6915823fa76245″,
    ″name″: ″LineItem″,
    ″children″: [
      {
        ″hash_id″: ″7339e7d00efedf431f6f578d84edebb06bf0f08d1a
555e8071382209419ae4cc″,
        ″child_count″: 1
      },
      {
        ″hash_id″: ″94ad5356e9d7ded23d4b367c8ce8a35e3ab597b2f
4d580782a548328ed7cd10″,
        ″child_count″: ″ ″
      },
      {
        ″hash_id″: ″b6dcf209bf21c13f658fc008bbf3478a89a70ecd
846870817efaeae82b10d41a″,
        ″child_count″: ″ ″
      }
    ]
  },
  ″Shape13: {
    ″hash_id″: ″90e436a37979d0bd0db768da4ee2b9bd3d5ced8b8131ac
38cc05ecc76ebc2fd5″,
    ″name″: ″LineItems″,
    ″children″: [
      {
        ″hash_id″: ″db40f91bb5294e0875c972fe86ec08c9b00711864aa
58a9d7c6915823fa76245″,
        ″child_count″: 1
      }
    ]
  },
  ″Shape 10″: ″″
    ″hash_id″: ″5b300c0d53c2f5ca56d5be779606879876194d7b2e
0282c3eb4dfa494b733f42″,
    ″name″: ″Summary″,
    ″children″: [
      {
        ″name″: ″TotalLineItemNumber″,
        ″type″: ″Integer″,
        ″qualifier″: ″ ″
      }
    ]
  },
  ″Shape14″: {
    ″hash_id″: ″b17895e5222185c74ad99563be6ddf7b882a41f
845961e5332056806663ca76c″,
    ″name″: ″OrderAck″,
    ″children″: [
      {
        ″hash_id″: ″1138111add72b054833b60c778b39d8ebe6a76b7f
313377a02a33c0397e7ca10″,
        ″child_count″: 1
      },
      {
        ″hash_id″: ″90e436a37979d0bd0db768da4ee2b9bd3d5ced8b
8131ac38cc05ecc76ebc2fd5″,
        ″child_count″: 1
      },
      {
        ″hash_id″: ″5b300c0d53c2f5ca56d5be779606879876194d7b
2e0282c3eb4dfa494b733f42″,
        ″child_count″: 1
      }
    ]
  },
  ″Shape 15″: {
    ″hash_id″ : ″621e1bd47e75c4a532be89a068f88b16f50b725f5b
66cb35b3396c54a30628e2″,
    ″name″: ″OrderAcks″,
    ″children″: [
      {
        ″hash_id″: ″b17895e5222185c74ad99563be6ddf7b
882a41f845961e5332056806663ca76c″,
        ″child_count″: 1
      }
    ]
  }
}
```

What is claimed is:

1. A method of analyzing data, the method comprising:
receiving document data comprising a plurality of data fields; and
defining a data shape from the document data, the data shape comprising one or more of the plurality of data fields.

2. The method of claim 1, wherein the data shape is defined agnostic to data content.

3. The method of claim 1, wherein the data shape further comprises a qualifier associated with a data field.

4. The method of claim 1, wherein the data shape is a first data shape, and the method further comprises defining a second data shape from the document data, the second data shape comprising one or more of the plurality of data fields.

5. The method of claim 4, wherein the second shape comprises the first shape and an additional element.

6. The method of claim 5, wherein the additional element is a data field

7. A method of analyzing data, the method comprising:
receiving first document data comprising a plurality of data fields;
defining at least one data shape within the first document data, each data shape comprising a grouping of data fields within the first document data;
receiving second document data comprising a plurality of data fields;
determining if a previously defined data shape is present within the second document data; and
determining if the second document data contains a new data shape.

8. The method of claim 7, further comprising assigning an identifier to each data shape and storing the identifiers.
